(19) United States
(12) Patent Application Publication
(10) Pub. No.: US 2003/0088858 A1
(43) Pub. Date: May 8, 2003

(54) Closed-loop design methodology for matching customer requirements to software design

(75) Inventor: Kevin Minerley, Red Hook, NY (US)

Correspondence Address: Sean F. Sullivan, Esq., Cantor Colburn LLP, 55 Griffin Road South, Bloomfield, CT, 06002, US

(73) Assignee: INTERNATIONAL BUSINESS MACHINES CORPORATION, ARMONK, NY

(21) Appl. No.: 10/014,701

(22) Filed: Nov. 7, 2001

(51) Int. Cl. G06F 9/45; G06F 9/44

(52) U.S. Cl. 717/141; 717/116

(57) ABSTRACT

A method for matching customer requirements communicated from a customer to a corresponding software design is disclosed. In an exemplary embodiment of the invention, the method includes gathering the customer requirements communicated from the customer and generating a machine-readable transcript of the customer requirements. A lexical analysis is run of the machine-readable transcript, thereby generating an output including one or more diagrammed sentences. The output of the lexical analysis is then mapped into object-oriented constructs. A high-level language design from an output of said mapping is then created.

### BACKGROUND

The present invention relates generally to object-oriented technology and, more particularly, to a methodology for improved matching of customer requirements to software design.

In order to maintain or enlarge their competitiveness, business enterprises of almost every type throughout the world are required to rework and bring up to date their information technology in order to meet their customer's requirements and thus to be successful in the market. However, keeping an information system based on traditionally developed software up to date is, at the least, an expensive undertaking. In certain cases, it may be an unsolvable problem altogether. Accordingly, Object Oriented Technology (OOT) has become a preferred software design methodology implemented to overcome problems associated with development, maintenance, and extension of software applications within a company's information system, as well as to provide interoperability and adaptability across multiple applications and hardware platforms.

Contrary to traditional, non-object oriented ways of developing software, OOT comprises and uses pre-engineered “methods” and “objects” for the development of software, somewhat analogous to tools and components for the development of an automobile. Just as each automobile component is not developed individually (but instead, standardized components are used which can be individually adapted to a desired specification), the same is true for methods and objects in OOT. OOT provides a “class” as a kind of software template from which individual objects can be instantiated. These classes are usually stored in a software library or a so called “class library”. A class library is simply a collection of several classes stored together in a special filing format called a library.

In OOT, an “object” is a self-contained piece of software consisting of related data and procedures. “Data” refers to information or space in a computer program where information can be stored (e.g., a name or an inventory part number). “Procedures” are parts of a program that cause the computer to actually perform a function (e.g., the parts of a program which perform calculations or the part of a program that stores something on a computer disk). An object's procedures are referred to as methods in OOT.

The concept of an object being a self-contained piece of software having data and procedures inside itself is a relatively new principle in software development. In non-object oriented software, most of the data for an entire program is often grouped together near the beginning of the program, and the procedures then follow this common pool of data. However, while this conventional method had sufficed in the past for smaller programs, it became increasingly difficult to determine which procedures were using which data as the software became more complex. This, in turn, resulted in greater difficulty and expense in debugging or changing traditional software programs. Thus, with OOT, it is generally easier to debug, maintain, and enhance object oriented software. Three of the most popular object oriented programming languages include “C++”, “JAVA”, (a trademark of Sun Microsystems) and “SMALLTALK” (a trademark of Xerox Corporation).

Although OOT is generally recognized to be the most sophisticated methodology for the development, maintenance, and extension of software applications, the software industry itself continues to look for techniques to automate the production of software. Presently, the process of translating customer's requirements to actual computer software involves tedious mapping into either formal or informal languages and methods. While the mapping process itself takes a great deal of skill and experience on the part of the software designer, it often fails to retain a one-for-one match with the original “human-described” customer requirements. As a result, the functional matching between the resulting software design and the initial customer requirements suffers.

Certain processes and products attempt to deal with and relate to system definition, software development, and the entire development cycle itself. For example, Unified Modeling Language (UML) is an object-oriented analysis and design language developed by the Object Management Group (OMG), a not-for profit corporation formed to create a component-based software marketplace by hastening the introduction of standardized object software. UML, however, requires a translation of a customer's requirements into a specialized language and diagram system that generally does not map one-for-one with the original thing being mapped.

### BRIEF SUMMARY

The foregoing discussed drawbacks and deficiencies of the prior art are overcome or alleviated by a method for matching customer requirements communicated from a customer to a corresponding software design. In an exemplary embodiment of the invention, the method includes gathering the customer requirements communicated from the customer and generating a machine-readable transcript of the customer requirements. A lexical analysis is run of the machine-readable transcript, thereby generating an output including one or more diagrammed sentences. The output of the lexical analysis is then mapped into object-oriented constructs. A high-level language design from an output of said mapping is then created.

In one embodiment, the customer requirements may be communicated orally, with the machine-readable transcript of the customer requirements being generated with voice recognition software. In another embodiment, the customer requirements may be communicated in writing, with the machine-readable transcript of the customer requirements being generated with optical character recognition software. Alternatively, the machine-readable transcript of the customer requirements may be generated from a computer file.

In a preferred embodiment, the mapping of the output of the lexical analysis into object-oriented constructs further includes: mapping nouns from the lexical analysis to objects, mapping verbs from the lexical analysis to process flows between the objects, mapping pronouns from the lexical analysis to nouns antecedent thereto, mapping adjectives from the lexical analysis to nouns, and mapping prepositions from the process flows between the objects. Preferably, the high-level language design is created in a language selected from the group consisting of C++, Java, and ADA.

### BRIEF DESCRIPTION OF THE DRAWINGS

FIG. 1 is a process flow diagram which illustrates a method for matching customer requirements to a corresponding software design, in accordance with an embodiment of the invention; and

FIG. 2 is another process flow illustrating an alternative embodiment of the method of FIG. 1.

### DETAILED DESCRIPTION

Disclosed herein is a methodology which proceeds directly from human discourse (i.e., written and oral communication), through a series of programs, and ultimately to computer software implementation of a customer's design request (thereby encapsulating the skill and experience needed to do other forms of mapping). The focus of the design process is thereby shifted away from the perspective of a preconceived or particular design methodology, and back to the actual customer requirement(s). As a result, the time to map and translate the customer's requirements to computer code is greatly reduced. Moreover, the end product is more likely to match the initial requirement as related by the customer. In turn, a reduced time to code may mean getting a product to market sooner, or perhaps may mean working iteratively with the customer so as to produce a final design that the customer is willing to purchase.

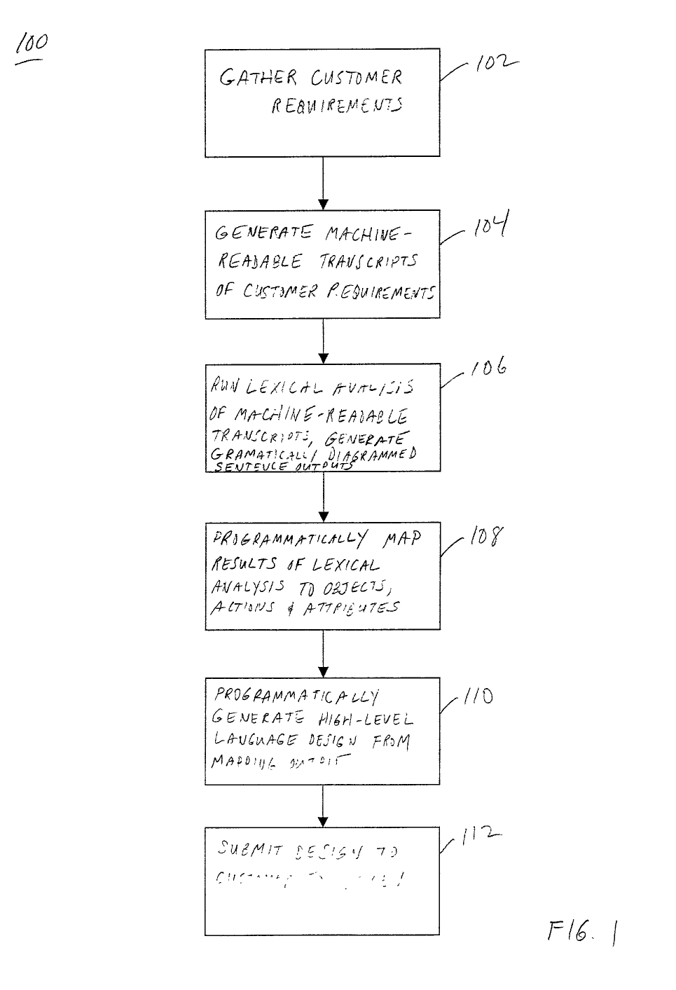

Referring now to FIG. 1, there is shown a process flow diagram which illustrates a method 100 for matching customer requirements to a corresponding software design, in accordance with an embodiment of the invention. Method 100 begins at block 102 where customer requirements are gathered in a form best suited or convenient for a customer. For example, the requirements may be spoken by customer and recorded by a designer. Alternatively, the requirements may be received in a written or typed document. Still a further possibility is to receive the requirements in a computer generated file.

Regardless of the format of the customer requirements, method 100 proceeds to block 104 where machine readable transcripts are programmatically generated from the initial customer requirements. For example, if the customer requirements are communicated verbally, transcription software such as Via Voice from IBM may be used to generate the machine readable transcripts. Or, if the customer requirements are submitted in typewritten or written form, then optical-character recognition (OCO) software may be used. If the customer used a computer to create requirements, the file created therefrom may be obtained and used in straight (flat-file) format. However, a tagged, intent-based language mapping format is also contemplated (e.g., SGML or XML). By implementing a machine readable transcript of customer requirements, the data generated therefrom may be subsequently analyzed.

Proceeding now to block 106, method 100 then passes the results of block 104 through a lexical analysis program having a full part-of-speech analysis capability. Exemplary applications include, but are not limited to, lexx or yacc for a Unix-based system, as well as IBM's CRITIQUE technology. Other suitable applications may be used so long as one of the possible outputs therefrom includes a diagrammed sentence output. Such outputs are also referred to as “transformational grammar diagrams”. The principal desired effect is the generation of a part-of-speech analysis that defines the grammatical properties or classifications of each word contained in the transcribed customer requirements. A transformational grammar diagram further extends the relationships inherent in the part-of-speech, and thus provides suitable one-to-one mapping with software constructs.

At block 108, the results of the lexical analysis from block 106 are programmatically mapped and assigned to objects, actions, and attributes, in accordance with object oriented programming principles. In Unix environments, Lexx and Yacc are suitable examples of such mapping applications. CMS Pipelines or TSO BatchPipes may be used with IBM mainframe host environments. The resultant output therefrom is an extended “data dictionary” which includes interrelationships. For example, nouns are mapped to objects or entities (i.e., pure data). Pronouns are mapped to antecedent nouns and thus represent a deferred addressing of objects/entities. Verbs are mapped to major process flows or entity relationships between objects, while adverbs provide properties or attributes to the flows. Adjectives further provide properties/attributes to nouns and thus to objects/entities. Prepositions are mapped to process flows between objects/entities (similar verbs). Verbs serve to tightly couple subjects and objects/entities, whereas prepositional phrases extend to the complete utterance.

Once the mapping process is completed, method 100 proceeds to block 110, where a high-level language design is programmatically created from the output of the mapping process. The design is preferably rendered in a language capable of object-oriented constructs, such as C++, Java, or ADA. ADA is most preferred as it allows a compile of the design, which is separate from the implementation. Alternatively, the output of the mapping process could also be rendered into UML and then feed into a third party software offering, such as Rational Rose (a model-driven development tool created by Rational Software), and then getting working IDL (Interactive Data Language, a trademark of Research Systems, Inc.) for any of several languages.

Finally, at block 112, the resulting design from block 110 (which maps directly to the customer input) is shown to the customer as a working model. Because the resulting design is generated from human-relayed specifications for software, directly to the design and implementation of the software, there is an improved correspondence and mapping correlation between the original human requirement and the implemented software. The above method 100 thus minimizes the “lost-in-translation” problem from requirements to implementation, as is often the case with existing software design methodologies. If necessary, however, the above-described steps may be reiterated as often as necessary for fine tuning in accordance with the customer's requirements, so as to facilitate a product, process, or solution to market.

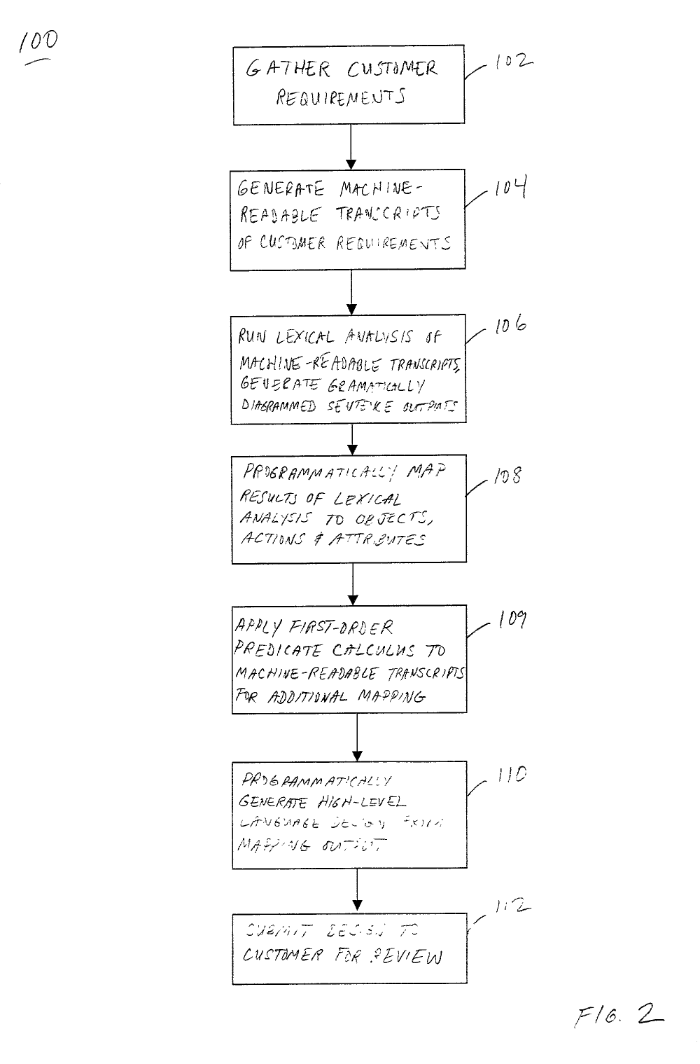

FIG. 2 illustrates an alternative embodiment of method 100. In this embodiment, an additional block 109 is added after block 108 to programmatically analyze the data in the machine readable transcripts of customer requirement (block 104) for first-order predicate calculus. Predicate calculus is a term used in logic which describes an analysis of the overall structure of the human discourse for larger relationships then those found at the sentential level. The results of the predicate calculus analysis may then be used to map further relationships between the objects. Applications that may be used for a first-order predicate calculus analysis include, but are not limited to, PROLOG, SNOBOL, LISP, Yacc, and Lexx.

Through the use of the above method embodiments, it will be appreciated that by employing intervening programs to transform human speech and/or writing and retaining the nouns/noun phrases as object/class names (with the adjectives as their properties) and using the verb/verb/prepositional phrases as the names of how the classes relate (methods), the ultimate result is a design and code that directly maps to a customer's requirements as evinced by the original writing and speech of the customer. As such, the design will more closely match the customer's business model and be more acceptable then another implementation (designed by conventional methodologies) less tightly coupled to the customer's needs.

The present invention can include embodiments in the form of computer-implemented processes and apparatuses for practicing those processes. The present invention can also include embodiments in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also include embodiments in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for matching customer requirements communicated from a customer to a corresponding software design, the method comprising:
gathering the customer requirements communicated from the customer;
generating a machine-readable transcript of the customer requirements;
running a lexical analysis of said machine-readable transcript, said lexical analysis thereby generating an output therefrom, said output including one or more diagrammed sentences;
mapping said output of said lexical analysis into object-oriented constructs; and
creating a high-level language design from an output of said mapping.

2. The method of claim 1, wherein:
the customer requirements are communicated orally; and
said machine-readable transcript of the customer requirements is generated with voice recognition software.

3. The method of claim 1, wherein:
the customer requirements are communicated in writing; and
said machine-readable transcript of the customer requirements is generated with optical character recognition software.

4. The method of claim 1, wherein said machine-readable transcript of the customer requirements is generated from a computer file.

5. The method of claim 1, wherein said mapping said output of said lexical analysis into object-oriented constructs further comprises:
mapping nouns from said lexical analysis to objects; and
mapping verbs from said lexical analysis to process flows between said objects.

6. The method of claim 5, wherein said mapping said output of said lexical analysis into object-oriented constructs further comprises:
mapping pronouns from said lexical analysis to said nouns antecedent thereto;
mapping adjectives from said lexical analysis to said nouns; and
mapping prepositions from said process flows between said objects.

7. The method of claim 1, wherein said high-level language design is created in a language selected from the group consisting of C++, Java, and ADA.

8. The method of claim 1, further comprising:
implementing a first-order predicate calculus analysis of said machine-readable transcript, said first-order predicate calculus used for additional mapping into said object-oriented constructs.

9. A storage medium encoded with a machine readable computer program code for matching customer requirements communicated from a customer to a corresponding software design, the storage medium including instructions for causing a computer to implement a method, the method comprising:
gathering the customer requirements communicated from the customer;
generating a machine-readable transcript of the customer requirements;
running a lexical analysis of said machine-readable transcript, said lexical analysis thereby generating an output therefrom, said output including one or more diagrammed sentences;
mapping said output of said lexical analysis into object-oriented constructs; and
creating a high-level language design from an output of said mapping.

10. The storage medium of claim 9, wherein:
the customer requirements are communicated orally; and
said machine-readable transcript of the customer requirements is generated with voice recognition software.

11. The storage medium of claim 9, wherein:
the customer requirements are communicated in writing; and
said machine-readable transcript of the customer requirements is generated with optical character recognition software.

12. The storage medium of claim 9, wherein said machine-readable transcript of the customer requirements is generated from a computer file.

13. The storage medium of claim 9, wherein said mapping said output of said lexical analysis into object-oriented constructs further comprises:
mapping nouns from said lexical analysis to objects; and
mapping verbs from said lexical analysis to process flows between said objects.

14. The storage medium of claim 13, wherein said mapping said output of said lexical analysis into object-oriented constructs further comprises:
mapping pronouns from said lexical analysis to said nouns antecedent thereto;
mapping adjectives from said lexical analysis to said nouns; and
mapping prepositions from said process flows between said objects.

15. The storage medium of claim 9, wherein said high-level language design is created in a language selected from the group consisting of C++, Java, and ADA.

16. The storage medium of claim 9, further comprising:
implementing a first-order predicate calculus analysis of said machine-readable transcript, said first-order predicate calculus used for additional mapping into said object-oriented constructs.

17. A computer data signal for matching customer requirements communicated from a customer to a corresponding software design, the computer data signal comprising code configured to cause a processor to implement a method, the method comprising:
gathering the customer requirements communicated from the customer;
generating a machine-readable transcript of the customer requirements;
running a lexical analysis of said machine-readable transcript, said lexical analysis thereby generating an output therefrom, said output including one or more diagrammed sentences;
mapping said output of said lexical analysis into object-oriented constructs; and
creating a high-level language design from an output of said mapping.

18. The computer data signal of claim 17, wherein:
the customer requirements are communicated orally; and
said machine-readable transcript of the customer requirements is generated with voice recognition software.

19. The computer data signal of claim 17, wherein:
the customer requirements are communicated in writing; and
said machine-readable transcript of the customer requirements is generated with optical character recognition software.

20. The computer data signal of claim 17, wherein said machine-readable transcript of the customer requirements is generated from a computer file.

21. The computer data signal of claim 17, wherein said mapping said output of said lexical analysis into object-oriented constructs further comprises:
mapping nouns from said lexical analysis to objects; and
mapping verbs from said lexical analysis to process flows between said objects.

22. The computer data signal of claim 21, wherein said mapping said output of said lexical analysis into object-oriented constructs further comprises:
mapping pronouns from said lexical analysis to said nouns antecedent thereto;
mapping adjectives from said lexical analysis to said nouns; and
mapping prepositions from said process flows between said objects.

23. The computer data signal of claim 17, wherein said high-level language design is created in a language selected from the group consisting of C++, Java, and ADA.

24. The computer data signal of claim 17, further comprising:
implementing a first-order predicate calculus analysis of said machine-readable transcript, said first-order predicate calculus used for additional mapping into said object-oriented constructs.
